(19) United States
(12) Patent Application Publication
(10) Pub. No.: US 2009/0040428 A1
(43) Pub. Date: Feb. 12, 2009

(54) Lightguide plate, planar light unit and display apparatus

(76) Inventor: Takashi Shimura, Yamanashi-ken (JP)

Correspondence Address: BRINKS HOFER GILSON & LIONE, P.O. BOX 10395, CHICAGO, IL, 60610, US

(21) Appl. No.: 12/221,812

(22) Filed: Aug. 7, 2008

(30) Foreign Application Priority Data
Aug. 8, 2007 (JP) JP2007-207242

(51) Int. Cl. G02F 1/1335; F21V 7/04

(52) U.S. Cl. 349/65; 362/622; 362/612

(57) ABSTRACT

A sheet-shaped lightguide plate has a substrate layer (1a) and resin layers (1b) formed on upper and lower surfaces of the substrate layer (1a). At least one of the resin layers (1b) has a plurality of microscopic optical configurations formed on the surface thereof to perform optical path conversion. A refractive index of the resin layers (1b) is set equal to or higher than a refractive index of the substrate layer (1a).

### RELATED APPLICATIONS

This application claims priority under 35 U.S.C. § 119 to Japanese Patent application No. JP2007-207242 filed on Aug. 8, 2007, the entire content of which is hereby incorporated by reference.

### BACKGROUND OF THE INVENTION

1. Field of the Invention

The present invention relates to a lightguide plate used in a planar light source that illuminates a liquid crystal display panel or the like. The present invention also relates to a planar light unit having the lightguide plate and also relates to a display apparatus having the planar light unit.

2. Description of the Related Arts

Liquid crystal display apparatus for image display are widely used in displays of mobile phones, personal digital assistants (PDAs), mobile personal computers (PCs), automatic teller machines (ATMs), etc. These liquid crystal display apparatus employ a backlight unit that applies illuminating light to a liquid crystal display panel from the back thereof to enhance the luminance of the display screen.

The backlight unit uses a lightguide plate that guides light from a light source, e.g. a fluorescent lamp or light-emitting diode (LED) light source, and emits the light toward a liquid crystal display panel from the entire area of a light exiting surface thereof that faces the liquid crystal display panel. Japanese Patent No. 3376508, for example, proposes a lightguide plate having a transparent substrate layer and a resin layer that has a light-scattering pattern and is formed on the resin substrate, and also proposes a planar light source apparatus including the lightguide plate. The transparent resin substrate used in such a lightguide plate is, generally, produced by injection molding process using an acrylic or polycarbonate resin, for example.

The above-described conventional technique, however, has the following problems to be solved.

With the lightguide plate in which a resin layer has a light-scattering pattern and is formed on a transparent resin substrate, a part of light guided through the transparent resin substrate is reflected at the interface between the resin layer and the transparent resin substrate and cannot enter the resin layer. Accordingly, the luminance of light emitted from the light exiting surface is not sufficiently high.

It has recently been demanded that lightguide plates should be thinner in order to reduce the weight and thickness of end products. When LEDs, which allow size reductions, are employed as a light source, in particular, the lightguide plate is required to be reduced in thickness correspondingly to the thickness of the LED light source. Conventionally, most lightguide plates are produced by using injection molding process. To form a lightguide plate having a wide area and yet reduced in thickness by the injection molding process, it is necessary to use a large-sized injection molding machine with high injection pressure in order to fill the resin material throughout the mold. The use of such a large-sized injection molding machine increases installation cost, resulting in an increase in product cost.

### SUMMARY OF THE INVENTION

The present invention has been made in view of the above-described problems with the conventional art. Accordingly, an object of the present invention is to provide a lightguide plate having a resin layer formed on a substrate, in which reflection at the interface between the substrate and the resin layer is reduced to obtain a high luminance at the light exiting surface, and, particularly, which is capable of exhibiting a high luminance even if it is reduced in thickness. Another object of the present invention is to provide a planar light unit having the lightguide plate of the present invention. Still another object of the present invention is to provide a display apparatus having the planar light unit of the present invention.

The present invention provides a lightguide plate including a substrate layer formed of a light-transmitting material and having a first surface, a second surface that are opposite to the first surface. The substrate layer further has a peripheral edge surface extending between peripheral edges of the first and second surfaces. The substrate layer is configured to receive light through a part of the peripheral edge surface. The lightguide plate further includes a resin layer formed on at least one of the first and second surfaces of the substrate layer. The resin layer has a plurality of microscopic optical configurations formed on a surface thereof to perform optical path conversion. The resin layer has a refractive index not lower than that of the substrate layer.

In the lightguide plate of the present invention, the refractive index of the resin layer formed on the substrate layer is set equal to or higher than the refractive index of the substrate layer. Therefore, most of light guided through the substrate layer also enters the resin layer without being totally reflected at the interface between the resin layer and the substrate layer and exits from the lightguide plate. Accordingly, a high luminance can be obtained at the light exiting surface of the lightguide plate.

The resin layer may be formed of an ultraviolet curing resin. In this case, an ultraviolet curing resin coating is applied to a surface of the substrate layer, and the resin coating is given a desired configuration by using a die. Thereafter, the resin coating is set by irradiation with ultraviolet (UV) radiation to form the resin layer. Accordingly, a large-sized and thin lightguide plate can be produced easily at a reduced cost.

The substrate layer may be formed of a sheet-shaped member. By so doing, a thin and large-sized lightguide plate can be produced at a reduced cost.

In addition, the present invention provides a planar light unit including the above-described lightguide plate and a light source having at least one light-emitting diode element to emit light into the lightguide plate. Because the planar light unit has the above-described lightguide plate, it is possible to efficiently emit guided light from the light exiting surface of the planar light unit and hence possible to obtain a high luminance.

In addition, the present invention provides a display apparatus including the above-described planar light unit and an image display panel disposed at a side of the planar light unit where it faces the resin layer. Because the display apparatus has the above-described planar light unit, high-luminance image display can be obtained.

The image display panel may be a liquid crystal display panel.

### BRIEF DESCRIPTION OF THE DRAWINGS

FIG. 1 is a sectional view of one embodiment of a lightguide plate according to the present invention.

FIG. 2 is a schematic sectional view of a display apparatus using the lightguide plate shown in FIG. 1.

FIG. 3 is a diagram for explaining the propagation of light in a lightguide plate having a substrate layer and resin layers, in which: part (a) illustrates the propagation of light in a conventional lightguide plate; and part (b) illustrates the propagation of light in the lightguide plate according to the present invention.

FIG. 4 is a graph showing the results of simulation of the luminance distribution on the light exiting surface of the lightguide plate according to the present invention in a case where the relationship between the refractive index n0 of the substrate layer and the refractive index n1 of the resin layer is n0<n1.

FIG. 5 is a graph showing the results of simulation of a second example of the luminance distribution on the light exiting surface of the lightguide plate according to the present invention in a case where the refractive index relationship is the same as in the case of FIG. 4.

FIG. 6 is a graph showing the results of simulation of the luminance distribution on the light exiting surface of the lightguide plate according to the present invention in a case where the refractive index relationship is n0=n1.

FIG. 7 is a graph showing the results of simulation of the luminance distribution on the light exiting surface of a lightguide plate in which the refractive index relationship is n0>n1.

FIG. 8 is a graph showing the results of simulation of the luminance distribution on the light exiting surface of a lightguide plate used as a reference for luminance comparison with the lightguide plate according to the present invention.

### DETAILED DESCRIPTION OF THE INVENTION

An embodiment of the present invention will be explained below specifically with reference to the accompanying drawings. It should be noted that the scale of the figures used in the following explanation is properly changed to show each member in a recognizable size.

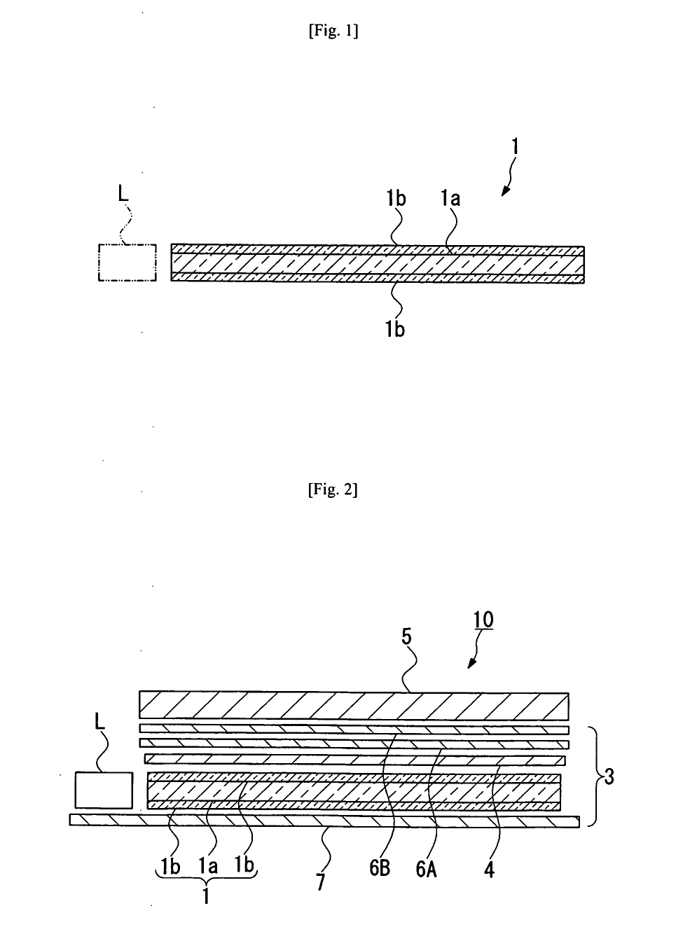

As shown in FIG. 1, a lightguide plate 1 according to one embodiment of the present invention has a substrate layer 1a and resin layers 1b formed on the upper and lower surfaces of the substrate layer 1a. At least one of the resin layers 1b has a plurality of microscopic optical configurations formed on a surface thereof to perform optical path conversion. The lightguide plate 1 receives light from a light source L through a light entrance surface that is a part of a peripheral edge surface thereof, propagates the light therethrough and emits it from a light exiting surface (upper surface in the illustrated embodiment) thereof.

The substrate layer 1a and the resin layers 1b are formed of a transparent polycarbonate or acrylic resin, for example. The lightguide plate 1 is a flat sheet shape formed by using a roll forming process, for example. The resin layers 1b are formed on the substrate layer 1a by using an ultraviolet (UV) curing resin.

To produce the substrate layer 1a by using roll forming process, a roll upper die and a roll lower die are prepared, and a resin sheet is put between the upper and lower dies and pressed therebetween under heating, thereby producing a thin sheet-shaped substrate layer 1a. The thickness of the substrate layer 1a is of the order of 100 μm, for example.

To produce the resin layers 1b by UV curing resin forming process, for example, a UV curing resin coating is applied to each of the upper and lower sides of the substrate layer 1a, and microscopic optical configurations are formed on the resin coating by using a die or the like. Further, the resin coating is irradiated with ultraviolet radiation by using a high-pressure mercury UV lamp or the like to cure the UV curing resin, thereby forming resin layers 1b that are thinner than the substrate layer 1a to a considerable extent.

It should be noted that examples of usable UV curing resins are photo reactive organic resins, e.g. acrylic, urethane, urethane acrylate and epoxy acrylate resins.

The above-described microscopic optical configurations may be selected from various configurations such as a plurality of convex dots or concave dots, convex or concave prisms each having a V-shaped sectional configuration, and prisms each having a scalene triangular sectional configuration. It should be noted that, in this embodiment, microscopic optical configurations are formed on the surface of the resin layer 1b which is disposed on the lower side of the substrate layer 1a. The height and pitch of the microscopic optical configurations are properly set in view of the size of the lightguide plate 1 and the luminance uniformity.

The refractive index of the resin layers 1b is set equal to or higher than that of the substrate layer 1a. For example, the resin layers 1b are formed of a polycarbonate (PC) resin, and the refractive index n1 thereof is set to 1.589. The substrate layer 1a is formed of a polymethylmethacrylate (PMMA; acrylic) resin, and the refractive index n0 thereof is set to 1.490.

In the actual production of a lightguide plate 1 for use in a mobile phone or the like, a large-sized sheet prepared as stated above is cut with a press or a cutter to obtain a sheet-shaped lightguide plate of a predetermined shape.

FIG. 2 shows a backlight unit 3 in a display apparatus 10 according to the present invention. The backlight unit 3 includes a plurality of light sources L each having at least one LED element (not shown), a lightguide plate 1 that receives light from the light sources L, a diffusing sheet 4 disposed over the lightguide plate 1 to receive light from the lightguide plate 1 and to emit it upward as uniformly diffused light, a pair of first and second prism sheets 6A and 6B disposed over the diffusing sheet 4 to receive light from the diffusing sheet 4 and to emit it upward as illuminating light directed toward a liquid crystal display panel 5, and a reflecting sheet 7 disposed underneath the lightguide plate 1.

In FIG. 2, the display screen of the liquid crystal display panel 5 and the light exiting surface of the backlight unit 3 are shown to face upward.

The lightguide plate 1 is fixedly secured by a holder (not shown) that supports another sheet member such as a prism sheet. The lightguide plate 1 and the sheet member may be fixed with double-coated adhesive tape.

The diffusing sheet 4 is formed by dispersing silica particles or the like into a transparent resin, e.g. an acrylic resin, or a polycarbonate resin.

The first prism sheet 6A and the second prism sheet 6B are transparent sheet-shaped members that collect light from the diffusing sheet 4 and direct it upward. The first and second prism sheets 6A and 6B have on their upper sides a plurality of mutually parallel elongated prisms. The respective prisms of the first and second prism sheets 6A and 6B extend to intersect each other as viewed from above the prism sheets 6A and 6B, i.e. in plan view. To obtain high directivity in the upward direction, in particular, the prisms of the first prism sheet 6A are set in a direction perpendicular to the above-described optical axis in plan view, and the prisms of the second prism sheet 6B are set parallel to the optical axis in plan view.

The reflecting sheet 7 is a metal sheet, film or foil having a light-reflecting function. In this embodiment, a film provided with an evaporated silver layer is employed as the reflecting sheet 7. It should be noted that an evaporated aluminum layer or the like may be used in place of the evaporated silver layer.

In this embodiment, the light sources L are white light sources. For example, a blue (wavelength λ: 470 to 490 nm) LED element or an ultraviolet (wavelength λ: less than 470 nm) LED element is formed by stacking a plurality of semiconductor layers of a gallium nitride compound semiconductor (e.g. InGaN compound semiconductor) on an insulating substrate, e.g. a sapphire substrate. The LED element is mounted on a substrate for a light source and sealed with a resin material to form an LED light source.

The resin material used to seal the LED element is formed by adding, for example, a YAG fluorescent substance into a silicone resin as a main component. The YAG fluorescent substance converts blue or ultraviolet light from the LED element into yellow light, and white light is produced by color mixing effect. It should be noted that various LED elements in addition to those described above can be used as the white LEDs.

The liquid crystal display panel 5 is a transmissive or semitransmissive liquid crystal display panel. In the case where the liquid crystal display panel 5 is the semitransmissive liquid crystal display panel, for example, it has a panel body having a liquid crystal material, e.g. TN liquid crystal or STN liquid crystal, sealed with a sealant in a gap between an upper substrate and a lower substrate, each having a transparent electrode layer, an alignment film and a polarizer. The semitransmissive liquid crystal display panel 5 further has a semitransmitting-reflecting sheet having both light-transmitting and -reflecting functions, which is provided underneath the panel body.

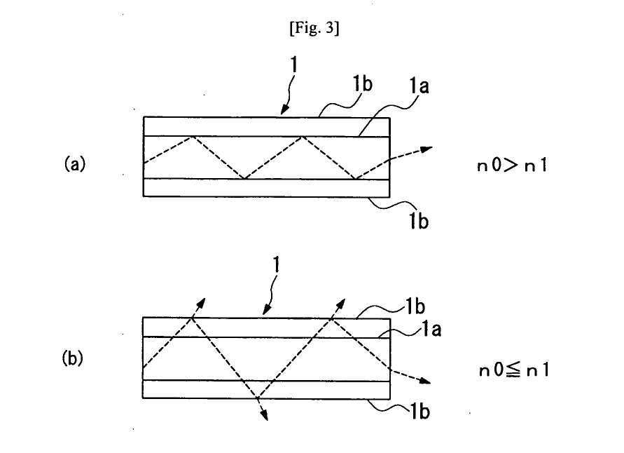

Let us explain guiding of light through the lightguide plate 1 and emission of light therefrom. For example, in a case where the refractive index of the resin layers 1b is lower than that of the substrate layer 1a, as shown in part (a) of FIG. 3, most of light guided through the substrate layer 1a is totally reflected at the interface between each of the resin layers 1b and the substrate layer 1a and cannot enter the resin layers 1b. In contrast, in the lightguide plate 1 of this embodiment, the refractive index of the resin layers 1b is equal to or higher than that of the substrate layer 1a. Therefore, as shown in part (b) of FIG. 3, light passes through the interface between each of the resin layers 1b and the substrate layer 1a to enter the resin layers 1b. Thus, an increased amount of light exits from the light exiting surface. Because the lower resin layer 1b has microscopic optical configurations formed on a surface thereof, the lightguide plate 1 can efficiently emit light from the light exiting surface (upper surface) thereof. In other words, the relationship between the refractive indices of the substrate layer 1a and the resin layers 1b is set in reverse to the case of optical confinement utilizing the refractive index relationship as in optical fibers. By so doing, light traveling through the substrate layer 1a is allowed to enter the resin layers 1b easily, and thus the light entering the lightguide plate 1 can be efficiently emitted from the light exiting surface.

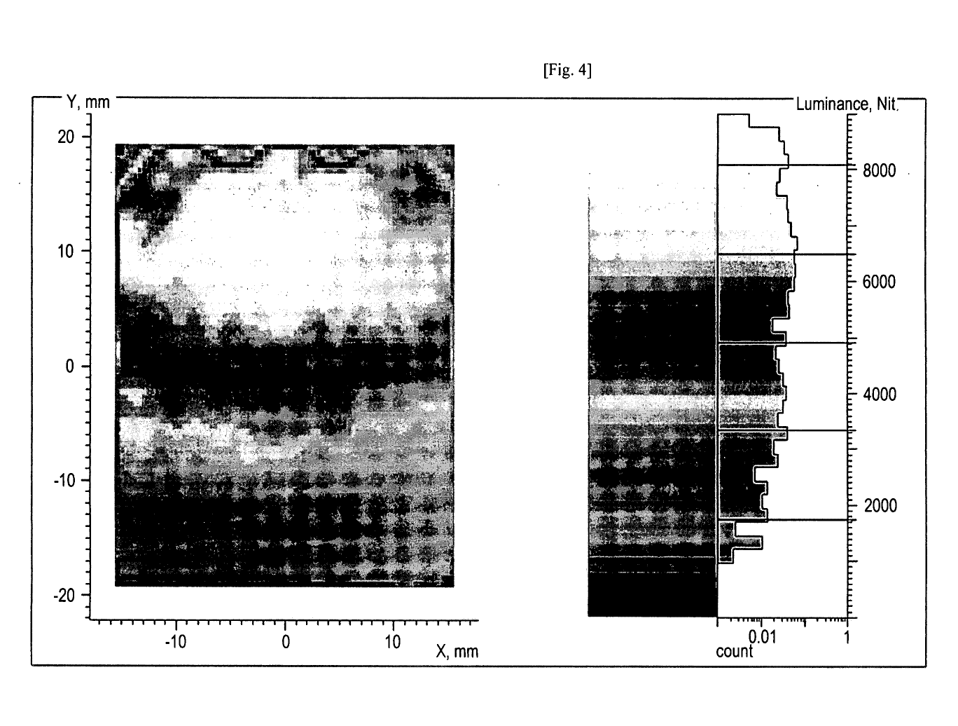

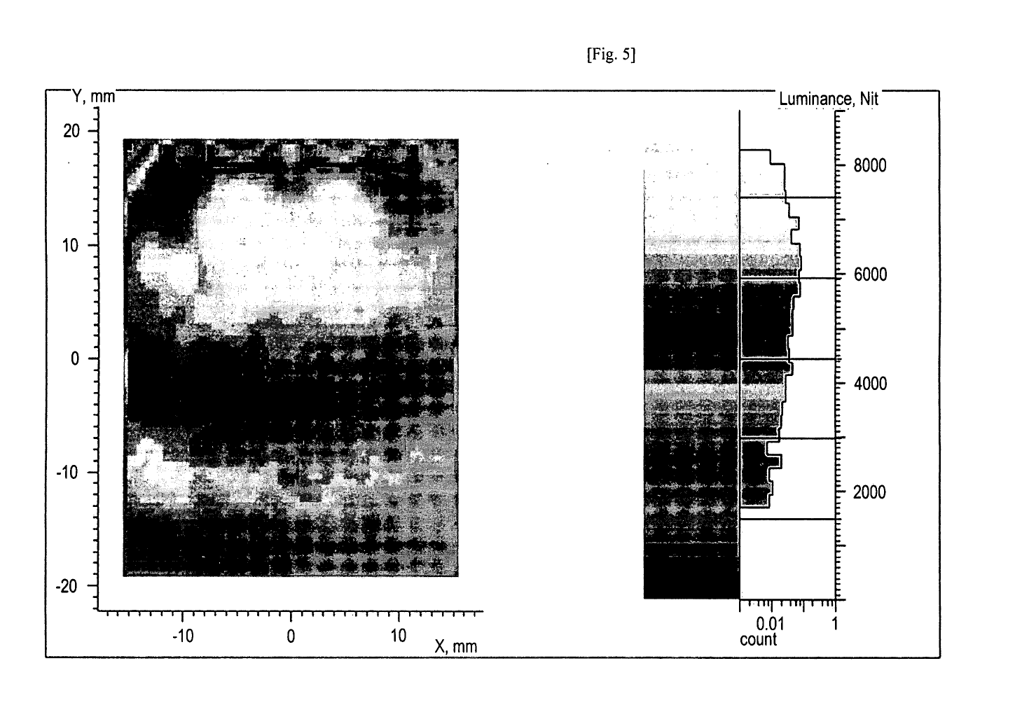

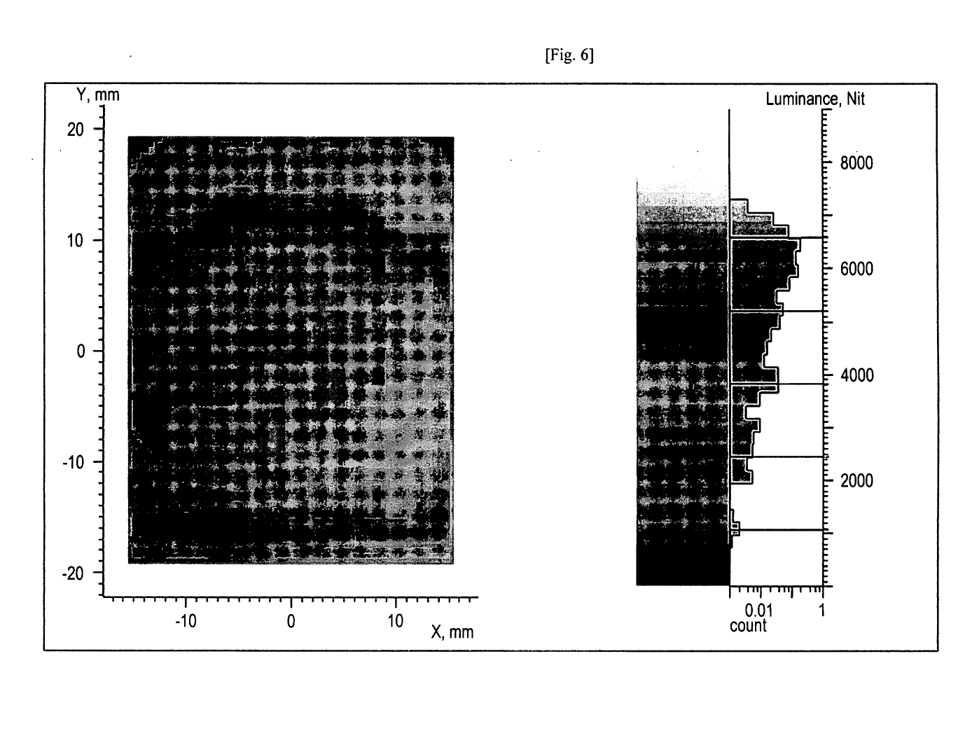

We simulated the average luminance at the light exiting surface and the luminance distribution in the plane of the light exiting surface for various, arbitrarily set refractive indices of the substrate layer 1a and the resin layers 1b. The results of the simulation will be explained below with reference to FIGS. 4 to 7. In each of these figures, the left-hand graph show the luminance distribution in the plane of the light exiting surface, and the right-hand graph shows the amount of exiting light at each part of the light exiting surface as seen from a side thereof along the vertical direction as seen in the figures.

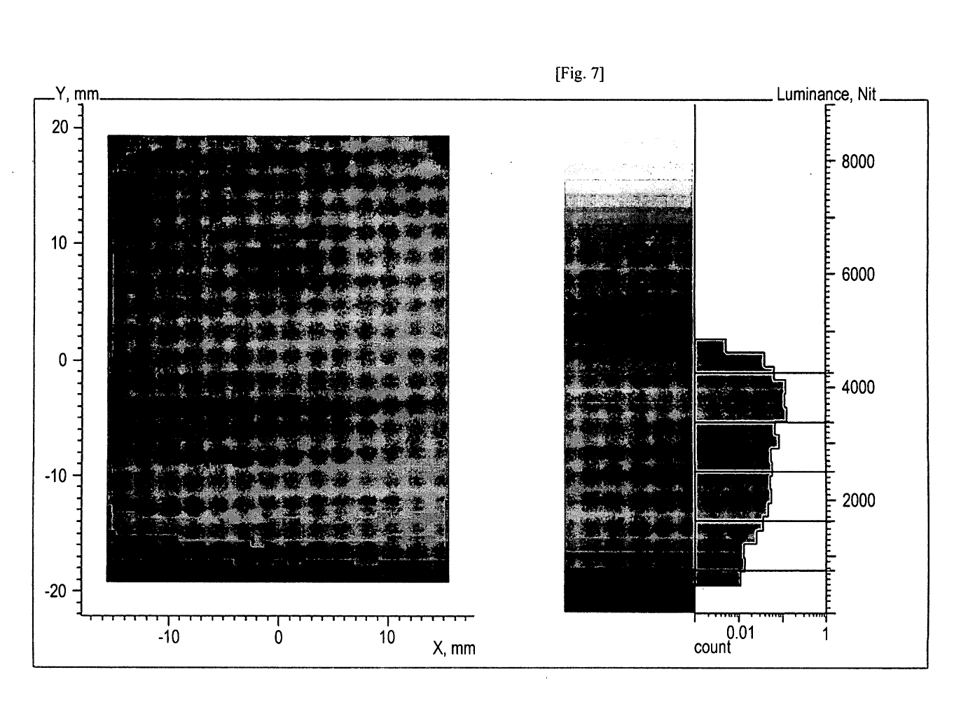

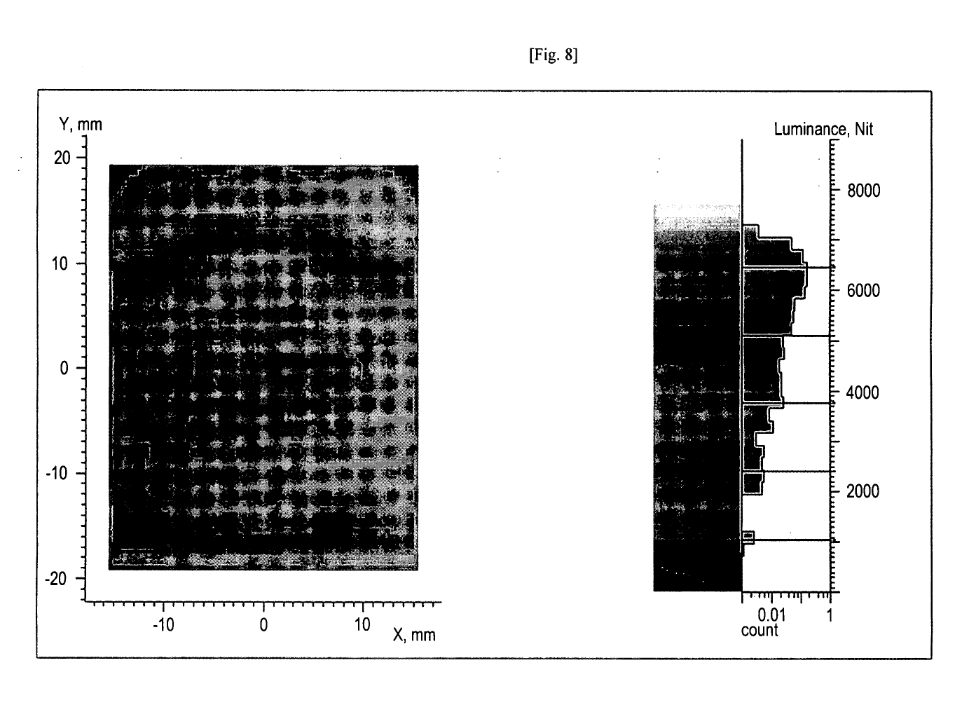

FIGS. 4 to 6 show the simulation results of Examples 1 to 3, respectively, of the lightguide plate 1 in this embodiment. In Example 1, the refractive index n0 of the substrate layer 1a was set to 1.49, and the refractive index n1 of the resin layers 1b was set to 1.58 (n0<n1). In Example 2, the refractive index n0 of the substrate layer 1a was set to 1.49, and the refractive index n1 of the resin layers 1b was set to 1.52 (n0<n1). In Example 3, the refractive index n0 of the substrate layer 1a was set to 1.58, and the refractive index n1 of the resin layers 1b was set to 1.58 (n0=n1). P FIG. 7 shows the simulation results of Comparative Example in which the refractive index n0 of the substrate layer 1a was set to 1.58, and the refractive index n1 of the resin layers 1b was set to 1.52 (n0>n1).

FIG. 8 shows the results of simulation with regard to a lightguide plate comprising only a substrate layer 1a having a refractive index n0 of 1.58 as Reference Example. It should be noted that the reflecting sheet 7 and other constituent elements were of the same settings for all the examples.

The results of the simulation reveal that the lightguide plate 1 of the present invention has been improved in average luminance to a considerable extent. That is, when the average luminance of Reference Example is assumed to be 100, the average luminance of Comparative Example is 48.3, whereas the average luminances of Examples 1 and 2 (n0<n1) are 89.3 and 93.2, respectively, and the average luminance of Example 3 (n0=n1) is 99.2. Thus, the highest luminance is obtained when the refractive index relationship is n0=n1 (Example 3). Comparison between Examples 1 and 2 reveals that a higher luminance is obtained with Example 2, in which the refractive indices of the substrate layer 1a and the resin layers 1b are closer to each other than in Example 1.

Thus, in the lightguide plate 1 of this embodiment, the refractive index of the resin layers 1b formed on the substrate layer 1a is set equal to or higher than the refractive index of the substrate layer 1a. Therefore, the lightguide plate 1 allows most of light guided through the substrate layer 1a to enter the resin layers 1b and to exit from the light exiting surface, without the light being totally reflected at the interface between each resin layer 1b and the substrate layer 1a. Accordingly, the lightguide plate 1 allows the guided light to enter the resin layers 1b and to exit from the light exiting surface efficiently and thus can obtain a high luminance at the light exiting surface.

In addition, the resin layers 1b are formed by UV curing resin forming process using a photo reactive resin that sets upon irradiation with ultraviolet (UV) radiation. Therefore, a large-sized and thin lightguide plate can be produced easily at a reduced cost. Specifically, a substrate layer 1a is formed by using a very thin member of the order of 100 μm in thickness, for example, and a UV curing resin is applied to the substrate layer 1a to form resin layers 1b. With this method, a very thin lightguide plate 1 can be produced. Thus, a backlight unit and a display apparatus that use the lightguide plate 1 can be reduced in thickness to a considerable extent. More specifically, the lightguide plate according to the present invention can be formed with a thickness of 0.1 mm for a mobile phone size of the order of 2 to 3 inches. For a mobile phone size of the order of 4 to 7 inches, the lightguide plate can be formed with a thickness of 0.2 to 0.3 mm. For a mobile phone size of the order of 8 to 13 inches, the lightguide plate can be formed with a thickness of 0.4 to 0.5 mm. If produced by the conventional injection molding process, these thin lightguide plates would cost a great deal.

Accordingly, the display apparatus 10 having the lightguide plate 1 can be constructed in a thin and large-sized structure at a reduced cost and yet can provide high-luminance image display.

It should be noted that the present invention is not necessarily limited to the foregoing embodiment but can be modified in a variety of ways without departing from the scope of the present invention.

For example, in the foregoing embodiment, microscopic optical configurations are formed on the surface of the resin layer 1b, which is disposed on the lower side of the substrate layer 1a. The resin layer 1b on the upper side of the substrate layer 1a may also be provided with microscopic optical configurations. In this case, the microscopic optical configurations formed on both sides of the substrate layer 1a may be the same or different from each other.

It is preferable from the viewpoint of achieving an increase in size and a reduction in thickness to make a sheet-shaped lightguide plate 1 having a structure comprising a plurality of layers, including a flexible sheet-shaped substrate layer 1a and a resin layer 1b provided on at least one surface of the substrate layer 1a, as stated above. The present invention, however, also includes a lightguide plate comprising a non-flexible plate-shaped substrate layer produced by injection molding process and a resin layer formed on surface of the substrate layer with the above-described refractive index relationship.

Although a diffusing sheet is used in the backlight unit of the foregoing embodiment, the diffusing sheet may be omitted. Although two prism sheets are used in the foregoing embodiment, the backlight unit may have only one prism sheet.

Although the foregoing embodiment employs a liquid crystal display panel as an image display panel, other types of image display panels may be used, for example, an electronic paper. In this case, the planar light unit including the lightguide plate according to the present invention is disposed as a front light unit at the front side of the electronic paper body.

What is claimed is:

1. A lightguide plate comprising:
a substrate layer formed of a light-transmitting material and having a first surface and a second surface that are opposite to each other, the substrate layer further having a peripheral edge surface extending between respective peripheral edges of the first surface and the second surface, the peripheral edge surface receiving light through a part thereof; and
a resin layer formed on at least one of the first surface and second surface of the substrate layer, the resin layer having a plurality of microscopic optical configurations formed on a surface thereof to perform optical path conversion;
the resin layer having a refractive index not lower than a refractive index of the substrate layer.

2. The lightguide plate of claim 1, wherein the resin layer is formed by an ultraviolet curing resin.

3. The lightguide plate of claim 1, wherein the substrate layer is formed of a sheet-shaped member.

4. The lightguide plate of claim 2, wherein the substrate layer is formed of a sheet-shaped member.

5. A planar light unit comprising:
the lightguide plate of claim 1; and
at least one light source each having at least one light-emitting diode element to emit light into the lightguide plate through the part of the peripheral edge surface of the substrate layer.

6. A planar light unit comprising:
the lightguide plate of claim 2; and
at least one light source each having at least one light-emitting diode element to emit light into the lightguide plate through the part of the peripheral edge surface of the substrate layer.

7. A planar light unit comprising:
the lightguide plate of claim 3; and
at least one light source each having at least one light-emitting diode element to emit light into the lightguide plate through the part of the peripheral edge surface of the substrate layer.

8. A planar light unit comprising:
the lightguide plate of claim 4; and
at least one light source each having at least one light-emitting diode element to emit light into the lightguide plate through the part of the peripheral edge surface of the substrate layer.

9. A display apparatus comprising:
the planar light unit of claim 5; and
an image display panel disposed at a side of the planar light unit and facing the planar light unit.

10. A display apparatus comprising:
the planar light unit of claim 6; and
an image display panel disposed at a side of the planar light unit and facing the planar light unit.

11. A display apparatus comprising:
the planar light unit of claim 7; and
an image display panel disposed at a side of the planar light unit and facing the planar light unit.

12. A display apparatus comprising:
the planar light unit of claim 8; and
an image display panel disposed at a side of the planar light unit and facing the planar light unit.

13. The display apparatus of claim 9, wherein the image display panel is a liquid crystal display panel.

14. The display apparatus of claim 10, wherein the image display panel is a liquid crystal display panel.

15. The display apparatus of claim 11, wherein the image display panel is a liquid crystal display panel.

16. The display apparatus of claim 12, wherein the image display panel is a liquid crystal display panel.
